(19) United States
(12) Patent Application Publication
(10) Pub. No.: US 2023/0101101 A1
(43) Pub. Date: Mar. 30, 2023

(54) LIFTING CHART FOR TOW VEHICLE

(71) Applicant: INDUSTRIES N.R.C. INC, Saint-Paul-d'Abbotsford (CA)

(72) Inventors: Sébastien DAIGNEAULT, Roxton Pond (CA); Philippe GIGUÈRE, Granby (CA); Normand CARON, Granby (CA); Benoit Landelle-Théberge, Granby (CA)

(21) Appl. No.: 17/949,525

(22) Filed: Sep. 21, 2022

Related U.S. Application Data
(60) Provisional application No. 63/249,088, filed on Sep. 28, 2021.

(51) Int. Cl. B66C 13/46; B60P 3/12; B66C 23/90; B66C 13/16; B60K 35/00

(52) U.S. Cl. CPC B66C 13/46; B60P 3/125; B66C 23/905; B66C 13/16; B60K 35/00; B66C 23/42

(57) ABSTRACT

An aid system for a wrecker adapted to perform a lifting operation of an object having a weight, the wrecker comprising an extendable boom wherein the extendable boom is adapted to perform the lifting operation through which the wrecker either hauls or lifts the object. The aid system comprises: sensors mounted to the wrecker adapted to collect intrinsic information associated with the wrecker and extrinsic information on the interaction of the wrecker with the operating environment or on the environment in which the lifting operation is performed; a processing unit adapted to collect and process data collected from the sensors to generate dynamic load chart data; and a display for displaying a graphical representation based on the dynamic load chart data, comprising a depiction of the wrecker and of a limit of an operating condition of the wrecker.

### CROSS-REFERENCE TO RELATED APPLICATION

This application relates to and is a non-provisional application claiming priority under 35 U.S.C. § 119(e) from U.S. patent application Ser. No. 63/249,088, filed Sep. 28, 2021, under 35 U.S.C. § 111, entitled LIFTING CHART FOR TOW VEHICLE, the specification of which is hereby incorporated herein by reference in its entirety.

### BACKGROUND

### (a) Field

The subject matter disclosed generally relates to towing and recovery vehicles. More particularly, the subject matter disclosed relates to towing parameter evaluation, indicators and controls associated therewith.

### (b) Related Prior Art

In the field of recovery vehicles, there are recovery vehicles with masts and booms, a.k.a. tow vehicles or wreckers, including those that can be rotated, a.k.a. rotating wreckers, as well as those which cannot be rotated, and whose supporting travel base can be moved along the longitudinal axis of the wrecker to increase the reach of the boom. Such large wreckers, a.k.a. heavy wreckers, allow a large load to be lifted and then moved to a given distance about the wrecker using hydraulic power.

Such recovery vehicles are for moving the recovered vehicle out of the way, which is frequently performed by towing the vehicle from the wrecking location to a repair location. The wreckers are designed to be able to tow maximum weights according to optimal operating parameters, and particularly designed to have a maximum lifted load supported by the towing arm or boom during the towing process.

Practically, the towed object having a weight and the lifted weight are frequently unknown or at least approximative, due to the variable nature of the towed vehicles and the conditions of the towed vehicles. Further, the conditions of lifting, hauling, etc., are frequently not optimal, such as not allowing to operate the outriggers to their full length, the ground uneven characteristics, the space require to move the lifted weight being limited by structures and objects in the vicinity, and the space requirement to enter and leave the space once the lifting operation performed.

Accordingly, the conditions in which lifting operations are performed vary. For instance, the extent of the towing arm may vary from one towing situation to the other, influencing the maximum towing capability of the wrecker.

Practically, wrecker operators frequently use operator load charts provided with the wrecker (see e.g., FIGS. 1A and 1B) providing in a visual manner for a specific boom orientation (e.g., FIG. 1A depicting the telescopic boom oriented rearward and associated lifting values, and FIG. 1B depicting the telescopic boom oriented sideways, the outriggers fully extended and associated lifting values).

Accordingly, it would be desirable to improve the knowledge provided to the wrecker operators in order to effectively respond to the variable weight of objects to lift and conditions to lift these objects, including limits in the extension of the wreckers and different orientations of the telescopic boom. It would therefore also be advantageous to provide wrecker controls that provide security improvements. It would further be desirable to provide dynamic data that can reflect changes that can occur in the lifting conditions during the operation.

Further, it would be desirable to provide a system that is operable on wreckers having different characteristics and features.

### SUMMARY

According to an embodiment, there is provided an aid system for a wrecker adapted to perform a lifting operation of an object having a weight, the wrecker comprising an extendable boom wherein the extendable boom is adapted to perform the lifting operation through which the wrecker either hauls or lifts the object. The aid system comprises: sensors mounted to the wrecker adapted to collect intrinsic information associated with the wrecker and extrinsic information on the interaction of the wrecker with the operating environment or on the environment in which the lifting operation is performed; a processing unit adapted to collect and process data collected from the sensors to generate dynamic load chart data; and a display for displaying a graphical representation based on the dynamic load chart data, comprising the wrecker and a limit of an operating condition of the wrecker.

According to an aspect, the processing unit is adapted to collect data from the sensors during the lifting operation and to dynamically change one of the graphical representations of the wrecker and the limit of the operating condition of the wrecker during the lifting operation.

According to an aspect, the aid system further comprises input means adapted for an operator to provide operator parameter being at least one of intrinsic information and extrinsic information, wherein the processing unit is adapted to generate simulation load chart data for the wrecker used for generating the graphical representation on the display.

According to an aspect, the limit of operating conditions comprises a periphery of an area.

In some aspects, the techniques described herein relate to an aid system for a wrecker adapted to perform a recovery operation of an object having a weight in an environment, the wrecker including a boom adapted to perform the recovery operation through which the wrecker either hauls or lifts the object, wherein the wrecker has operating limits, the aid system including: sensors mounted to the wrecker adapted to collect: intrinsic information associated with the wrecker, including detection of a first current operation state of the wrecker among a plurality of available operation states; and extrinsic information on interaction of the wrecker with the environment or on the object; a processing unit adapted: to collect intrinsic data and extrinsic data from the sensors; to process the intrinsic data, the extrinsic data and the operation limits of the wrecker; and to generate dynamic load chart data based on the processing of the data; and a display adapted for displaying an operations center depicting a dynamic load chart based on the dynamic load chart data, the operations center depicting a) at least part of a wrecker representation in the first current operating state of the wrecker, and a limit depiction of an operating condition of the wrecker in the first current operating state of the wrecker.

In some aspects, the techniques described herein relate to an aid system, wherein the intrinsic information includes weight distribution of the wrecker.

In some aspects, the techniques described herein relate to an aid system, wherein the intrinsic information includes at least one of extension of the boom, orientation of the boom, and elevation angle of the boom.

In some aspects, the techniques described herein relate to an aid system, wherein the extrinsic information includes force exerted by the ground on outriggers laid over the ground.

In some aspects, the techniques described herein relate to an aid system, wherein the sensor are adapted to detect a change from the first current operating state to a second current operating state, and for modifying at least one of the representation of the at least part of the wrecker representation and the limit of the operating condition in the operations center.

In some aspects, the techniques described herein relate to an aid system, wherein the aid system is operable in a simulation mode through which an operating route is set, and an operating mode in which the wrecker operated in a series of current operation states, wherein in the operation mode the processing unit is adapted to detect gap between the current operating states of the series of current operating states and the operating route.

In some aspects, the techniques described herein relate to an aid system, further including memory adapted to store at least one of the operating route, and the series of current operating states.

In some aspects, the techniques described herein relate to an aid system, wherein the operations center includes a first zone depicting a bird's eye view of the at least part of the wrecker and the limit depiction, and a second zone depicting an elevation view of at least part of the boom and the limit depiction.

In some aspects, the techniques described herein relate to an aid system, wherein the operations center further includes a representation of at least one of: a force or a force rating exerted on an outrigger; weight of the object; elevation angle of the boom; a force or a force rating exerted on a cable or on a drum; oil flow; oil pressure; oil temperature; and working pressure.

In some aspects, the techniques described herein relate to an aid system, wherein the operations center includes at least two scale bars, and at least two indicators each located on one of the scale bars based on the first current operating state.

In some aspects, the techniques described herein relate to an aid system, wherein the operations center further includes a stability notification processed by the processing unit based on the intrinsic data, the extrinsic data the operating limits and the first current operating state.

In some aspects, the techniques described herein relate to a wrecker adapted to perform a recovery operation of an object having a weight in an environment, the wrecker including: a boom adapted to perform the recovery operation through which the wrecker either hauls or lifts the object; operating limits associated with components of the wrecker; sensors mounted to the wrecker adapted to collect: intrinsic information associated with the wrecker, including detection of a first current operation state of the wrecker among a plurality of available operation states; and extrinsic information on interaction of the wrecker with the environment or on the object; and an aid system including: a processing unit adapted: to collect intrinsic data and extrinsic data from the sensors; to process the intrinsic data, the extrinsic data and the operation limits of the wrecker; and to generate dynamic load chart data based on the processing of the data; and a display adapted for displaying an operations center depicting a dynamic load chart based on the dynamic load chart data, the operations center depicting a) at least part of a wrecker representation in the first current operating state of the wrecker, and a limit depiction of an operating condition of the wrecker in the first current operating state of the wrecker.

In some aspects, the techniques described herein relate to a wrecker, wherein the intrinsic information includes at least one of extension of the boom, orientation of the boom, and elevation angle of the boom.

In some aspects, the techniques described herein relate to a wrecker, further including outriggers, wherein the extrinsic information includes force exerted by the ground on the outriggers pressed against the ground.

In some aspects, the techniques described herein relate to a wrecker, wherein the sensor are adapted to detect a change from the first current operating state to a second current operating state of the wrecker, and for modifying at least one of the representation of the at least part of the wrecker representation and the limit of the operating condition in the operations center.

In some aspects, the techniques described herein relate to a wrecker, wherein the operations center includes a first zone depicting a bird's eye view of the at least part of the wrecker and the limit depiction, and a second zone depicting an elevation view of at least part of the boom and the limit depiction.

In some aspects, the techniques described herein relate to a wrecker, wherein the operations center includes at least two scale bars, and at least two indicators each located on one of the scale bars based on the first current operating state.

In some aspects, the techniques described herein relate to a method of operating a wrecker equipped with a boom, sensors, and an aid system including a processing unit connected to the sensors and a display, the method including the steps of: hooking an object having a weight to the boom; providing an operations center on the display, the operations center depicting a dynamic load chart based on dynamic load chart data generated by the processing unit, the operations center depicting a) at least part of a wrecker representation in a first current operating state of the wrecker, and a first limit depiction of an operating condition of the wrecker in the first current operating state of the wrecker, receiving a command from the operator resulting in a change from the first current operating state to a second operating state, and modifying the operations center for the operations center to depict a) at least part of a wrecker representation in the second current operating state, and a second limit depiction of an operating condition of the wrecker in the second current operating state of the wrecker.

In some aspects, the techniques described herein relate to a method, including, prior to the step of receiving a command, the steps of: initiating a simulation mode with an assertion of a weight of the object; receiving a series of simulation commands from the operator; providing the operations center on the display, the operations center depicting a dynamic load chart based on dynamic load chart data generated by the processing unit based on the asserted weight and the simulation commands, the operations center depicting concurrently a) an animation of at least part of a wrecker representation according to simulation commands, and a depiction of simulation operating conditions of the wrecker according to the asserted weight and the simulation commands.

In some aspects, the techniques described herein relate to a method, including, prior to the step of receiving a command, the steps of: initiating a simulation mode with at least an assertion of a weight of the object; establishing an operation route based on the assertion of the weight of the object; and placing in the wrecker in a location and orientation set in the operating route.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1A is an example of the PRIOR ART of an operator chart provided with the wrecker providing information on operating limits of the wrecker when the telescopic boom is oriented rearward;

FIG. 1B is another example of the PRIOR ART of an operator chart provided with the wrecker providing information on operating limits of the wrecker when the telescopic boom is oriented sideways;

FIG. 2 is a perspective view of the rear of a wrecker in accordance with an embodiment;

FIG. 3 is a realization of a wrecker comprising a different number of axles and extended mid-length and rear outriggers in accordance with an embodiment;

FIG. 4 is a rear perspective view of the body of a wrecker in accordance with an embodiment showing the slidable boom assembly in its frontmost position, the telescopic boom being oriented at a position between aligned with the body and perpendicular to the body with no elevation thereof;

FIG. 5 is a perspective view of a wrecker with illustration of locations and types of sensors mounted to the wrecker in accordance with an embodiment;

FIG. 6 is a schematic of an operations center providing information relative to the wrecker in an operating state, wherein the operations center comprises representations of operating limits in accordance with an embodiment;

FIG. 7 is a schematic of a visual interface for a simulation mode in accordance with an embodiment;

FIG. 8 is a schematic showing a representation of the wrecker and camera controls allowing to select a camera to provide its capture on the display;

FIG. 9 is a schematic of components of the aid system of a wrecker in accordance with an embodiment; and

FIG. 10 is a flow chart of depicting exemplary uses of the aid system in a recovery operation.

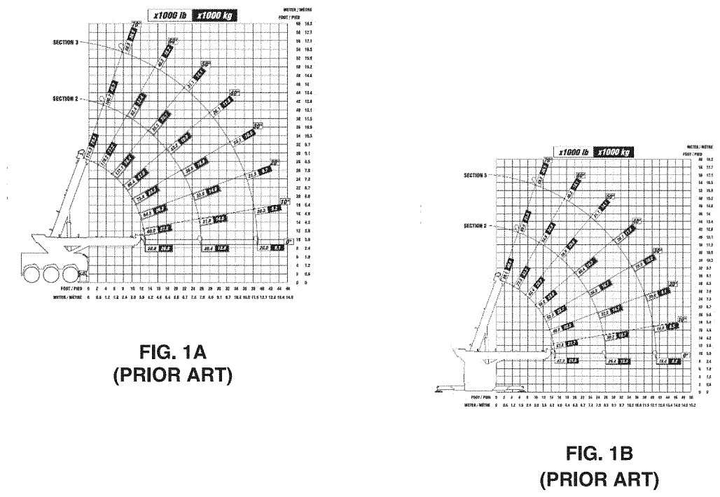

It will be noted that throughout the appended drawings, like features are identified by like reference numerals.

### DETAILED DESCRIPTION

The realizations will now be described more fully hereinafter with reference to the accompanying figures, in which realizations are illustrated. The foregoing may, however, be embodied in many different forms and should not be construed as limited to the illustrated realizations set forth herein.

With respect to the present description, references to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values and of values herein or on the drawings are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described realizations. The use of any and all examples, or exemplary language (“e.g.,” “such as,” or the like) provided herein, is intended merely to better illuminate the exemplary realizations, and does not pose a limitation on the scope of the realizations. No language in the specification should be construed as indicating any unclaimed element as essential to the practice of the realizations.

In the following description, it is understood that terms such as “first”, “second”, “top”, “bottom”, “above”, “below”, and the like, are words of convenience and are not to be construed as limiting terms.

The terms “top”, “up”, “upper”, “bottom”, “lower”, “down”, “vertical”, “horizontal”, “front”, “rear”, “interior” and “exterior” and the like are intended to be construed in their normal meaning in relation with normal operation of a wrecker.

It should further be noted that for purposes of this disclosure, the terms “coupled” or “connected” mean the joining of two members directly or indirectly to one another. Such joining may be stationary in nature or movable in nature and/or such joining may allow for the flow of fluids, electricity, electrical signals, or other types of signals or communication between two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

It should further be noted that for purposes of this disclosure, the terms “representation”, “illustration” and “depiction” are intended to have a similar meaning of providing visual communication.

In realizations, there are disclosed in the present description a wrecker comprising an aid system for dynamically assessing and for providing displaying a graphical representation of the wrecker in its environment and a limit of operating conditions of the wrecker.

In realizations, there are disclosed in the present description a wrecker comprising an aid system, which according to embodiments is for dynamically assessing and providing a graphical representation of limits or operations of the boom and cables for hauling/lifting of the wrecker.

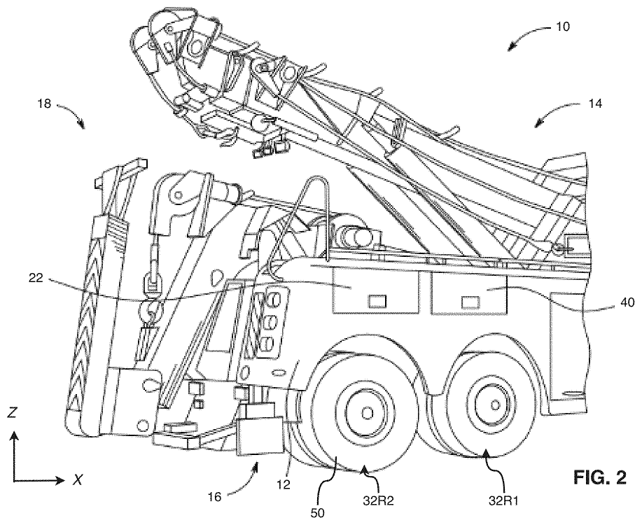

Referring now to the drawings, and more particularly through FIGS. 2 to 5 is depicted a wrecker 10 adapted to perform a recovery operation of an object having a weight in an environment, wherein the wrecker 10 either hauls or lifts the object. The wrecker 10 comprises a body 12 mounted on a frame, aka chassis 16. The wrecker 10 comprises a telescopic boom 14 mounted on rotating bearings, which is in turn mounted on a travel base assembly 42. The travel base assembly 42 moves over travel tubes mounted on the chassis 16 along the longitudinal axis of the chassis 16 of the wrecker 10. The travel base assembly 42 is mounted on bearing pads or alternatively on one or more traveler rollers to be able to travel over the tubes.

Accordingly, based at least on the longitudinal displacement of the telescopic boom 14 relative to the body 12, the orientation of the telescopic boom 14, its extension, the distribution of the weight of the wrecker 10 and the charge the boom may lift vary significantly.

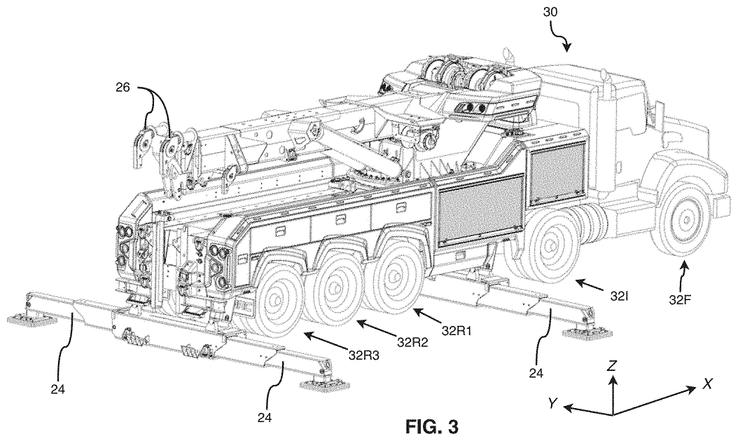

The wrecker 10 further comprises lifting cables 26 (depicted on the FIG. 3) wound upon a winch assembly 28, wherein the lifting cables 26 are guided by the telescopic boom 14 and are attached to the object to be lifted during lifting operations.

The wrecker 10 may further comprise an underlift arm 18, mounted on the rear portion of the chassis 16 of the wrecker 10 and comprising a main arm 38. The wrecker body 12 comprises interior compartments along at least one of its sides, the interior compartments comprising a control cabinet 40 and a tool cabinet 22. The wrecker 10 further comprises a cabin 30 from which the operator drives the wrecker 10 during towing operations.

In some realizations, the wrecker 10 comprises outriggers 24 (see e.g., FIG. 3) that are extendable arms mounted to the chassis 16 adapted to lay over the ground for improved stability, wherein the outriggers 24 are variably extendable between a collapsed position, not extending beyond the side of the body 12 of the wrecker 10 (see e.g., FIG. 2), and a fully extended position wherein the outriggers 24 provide the wider support to the chassis 16 of the wrecker 10, (see e.g. FIG. 3). The outriggers 24 are present and extendable on both sides of the chassis 16. The outriggers 24 are designed to abuts against the ground to provide extra stability to the wrecker 10 during non-moving phases of operations. According to realizations, the wrecker 10 may comprise no outrigger, two (2) outriggers, four (4) outriggers 24 (e.g., rear outriggers and mid-length outriggers depicted on FIG. 3) extending sideways, and optionally extra outriggers extending longitudinally frontward or rearward (realization not depicted), or even orientable outriggers extending at an angle between the longitudinal direction and the transversal direction. In some realizations, some outriggers 24 may not be able to extend away from the chassis 16 but rather be able only to extend and abut against the ground below the chassis 16, thereby releasing some weight over the wheels 50 (see FIG. 3) and providing extra stability since the outriggers 24 are rigid parts that allow less displacement than inflated elastomer-based tires.

The wrecker 10 may further comprise open and/or closable storage space to store tools and operating accessories (e.g., chains, hooks) the operator may decide to store in the wrecker based on planned operations, wherein the tools and accessories also influence the distribution of weight of the wrecker 10.

As shown in FIGS. 2 and 3, the wrecker 10 comprises a plurality of axles, among which one or more front axles 32F (herein generically referred to as 32F and depicted as a single front axle 32F, not shown) and one or more rear axles 32R (herein generically referred to as 32R and depicted as a first rear axle 32R1, a second rear axle 32R2 and a third rear axle 32R3). In some embodiments, the wrecker 10 may comprises one or more intermediary axles 32I (herein generically referred to as 32I)

Available model of existing wreckers 10 differ from each other in the number of axles 32F, 32I and 32R, and the physical characteristics of the wrecker 10 such the distribution of the weight of the wrecker 10 without payload and accessories, the wheelbase of the wrecker 10, the available components (e.g., outriggers 24, underlift arm 18), the capacity of the wrecker 10 to store optional components (e.g., chains, cables, cable guides, hooks, etc.) and the maximum capacity of some particular components of the wrecker 10.

Further, the operating conditions of a same wrecker 10 differ from one operation to the other based on the equipment mounted to the wrecker 10 at the time, the location and ground condition, the use of the removable, movable, and fixed equipment (e.g., telescopic boom 14, outriggers 24), and the environmental conditions (e.g., longitudinal and transversal angles of operations of the wrecker 10 relative to the horizontal, and obstacles present in the vicinity).

The above conditions therefore define a set of intrinsic conditions depending solely on the condition of the wrecker 10 at the time to perform the operation (e.g. the total weight of the wrecker 10 performing the function of counterweight necessary for stability of the wrecker 10 during lifting operations, and distribution of that weight over the chassis 16 of the wrecker 10), and, all others being a set of extrinsic conditions depending on the interaction of the wrecker 10 with the environment (e.g. obstacles and the driveway condition limiting the possible positions the wrecker 10 may operate in, the maximum extend of at least some of the outriggers 24, structures in the vicinity limiting displacement and operating angle of the telescoping boom, structures in the vicinity limiting the potential displacement of an object once lifted, ground condition, etc.) and non-related conditions (weight of the object).

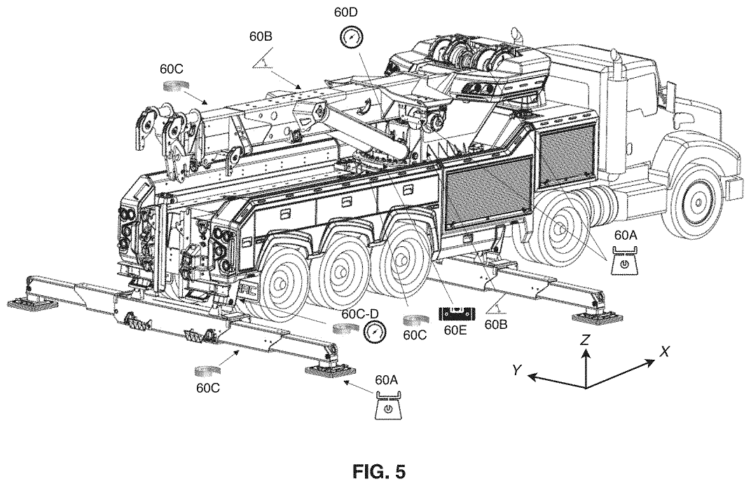

Referring to FIG. 5, the wrecker 10 comprises a series of sensors 60 of different types and distributed at different strategic locations that are used to collect data, including data for detection of the current state of operation of the wrecker 10, comprising the position of the telescopic boom 14 relative to the chassis 16 of the wrecker 10, the extension of the telescopic boom 14, the orientation of the telescopic boom 14, the elevation angle of the telescopic boom 14. State of operation may comprise tension on a cable, extension of a cable, and other relative to other components of the wrecker 10 involved in the lifting.

According to realizations, the sensors 60 comprises load sensors 60A mounted to the body 12, the chassis 16 and/or the axles 32F, 32I, 32R allowing to determine the weight of the wrecker 10 body including the fuel, the operator (when applicable), the optional components mounted to or stored on the wrecker 10, etc. and their weight distribution.

According to a realization, the sensors 60 comprises accelerometers 60E or equivalent to evaluate the angle of the wrecker 10 relative to the horizontal.

According to a realization, the sensors 60 comprises extend sensors 60C to monitor the extend of the outriggers 24, wherethrough both weight distribution and footing of the wrecker are changed. It also comprises load sensors 60A associated with the outriggers 24 designed to monitor forces undergone by the outriggers 24, and particularly forces the outriggers 24 exert against the ground.

According to a realization, the sensors 60 comprises cable sensors (not identified on Figure) to monitor length, tension and/other characteristics of the lifting cables 26 and/or the winch assembly 28 during a lifting operation.

According to a realization, the sensors 60 comprises sensors 60 dedicated to monitor operating parameters specifically associated with the telescopic boom 14, e.g., its orientation, the angle the telescopic boom 14 operates in, and the extension of the telescopic boom 14. According to a realization, it further includes position sensor for displacement of the base of the boom 14 relative to the chassis 16.

As depicted on FIG. 5, according to a realization, the sensors 60 are adapted to monitor loads (e.g., sensor 60A), angles of operations (e.g., sensor 60B), stress and/or extensions (e.g., sensor 60C), fluid pressure (e.g., sensor 60D), and level (e.g., sensor 60E).

Data collected from the sensors 60 are used to determine intrinsic information defining the actual characteristics of the wrecker 10 when ready to perform a lifting operation, such the weight and distribution of weight of the wrecker.

Data collected from the sensors 60 are also used to determine extrinsic information defining the conditions specific to the environment wherein the operation takes place and the condition (e.g., the weight of the object to be lifted) of operation of the lifting operation.

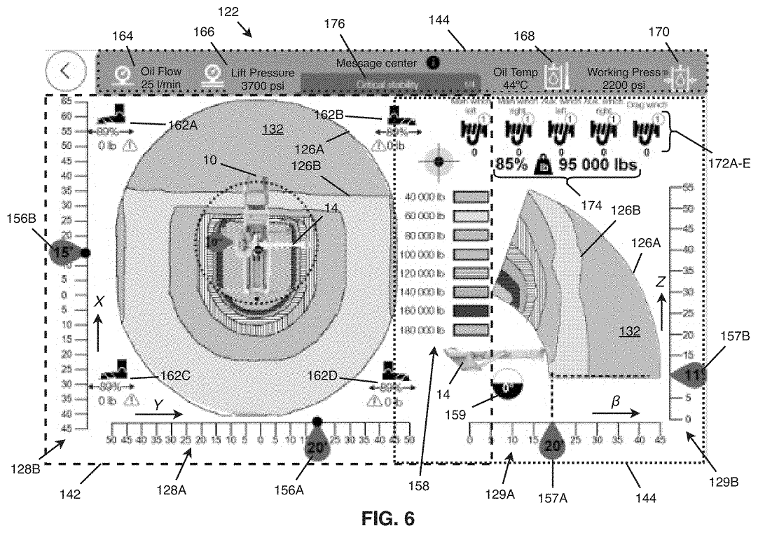

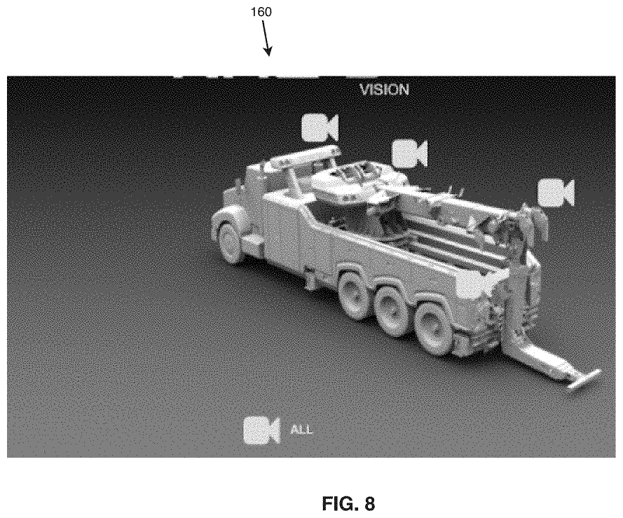

Referring additionally to FIGS. 6 to 9, a wrecker 10 comprising an aid system 100 comprises sensors 60 connected to a processing unit 110 adapted to retrieve data from the sensors 60. The processing unit 110 is further connected to a display 120 that is able, based on data generated by the processing unit 110, to display an operations center 122 of a dynamic load chart comprising a wrecker representation 124 and at least one operating limit 126.

The processing unit 110 is adapted to operate in cooperation with memory 112 and program codes 114 to process the data collected by the sensors 60 and the data registered in the memory specific to the wrecker 10, and to process the data according to the program codes to obtain dynamic load chart data, i.e., data to are updated in real time during a recovery operation. According to a preferred realization, the processing unit 110 is also responsible for embodying the dynamic load chart data in the operations center 122 displayed on the display 120, the operations center 122 providing the information to the operator in an understandable manner allowing the operator to make decisions and transform the data into physical operations.

According to embodiments, the display 120 consists in at least one of a) a display attached to the wrecker 10, for example in the cabin 30 or close to the controls of the boom 14, for instance in the control cabinet 40, b) a remote device dedicated to the operating exclusively with the wrecker 10, comprising control dedicated to the operation of the aid system or alternatively comprising controls dedicated to the operation of the aid system and to the operation of the wrecker components such as the outriggers 24, and the telescopic boom 14, and c) a generic remote device such as a tablet or a smartphone adapted with an application and communication capability through which the remove device is adapted to initiate communication and maintain communication with the wrecker 10, though remove communication components and standards such as one cellular communication standard, or Peer-to-Peer technologies such as Bluetooth™ standard and Wi-Fi direct.

According to a realization, at least the display 120 of the aid system 100 is located in the control cabinet 40, e.g., a cabinet designed according to the parameters described in U.S. Pat. No. 9,981,832, issued to the present Applicant, whereby the display 120 may be stored in a closed protective cabinet when not used and extended outside the cabinet for particular use.

According to a realization, at least some of the controls and/or the information provided by the aid system 100 are available through a remote control (e.g., remote display 120), wherein the remote control allows the operator to evaluate and/or perform some operations while being located away from the wrecker 10. Such remote control allows the operator in some situations to operate from a more secured location or from a location providing a better perspective of the operation and thereby allowing better selection of the sub-operations to be performed and their order.

Back to the operation of the aid system 100, before and during a lifting operation, the processing unit 110 is adapted to generate and update dynamic load chart data based on the data collected by the sensors 60 and known data relative to the wrecker 10, e.g., the lifting capacity of the wrecker 10. Thereby the graphical representation based on the dynamic load chart data allows the operator to plan lifting operation, monitor the lifting operation to ensure that the lifting plan is respected, and react to unforeseen situations that may occur during the lifting operation (e.g., the ground under one of the outriggers 24 being unstable when initially deemed stable, something hooked to the lifted object, etc.).

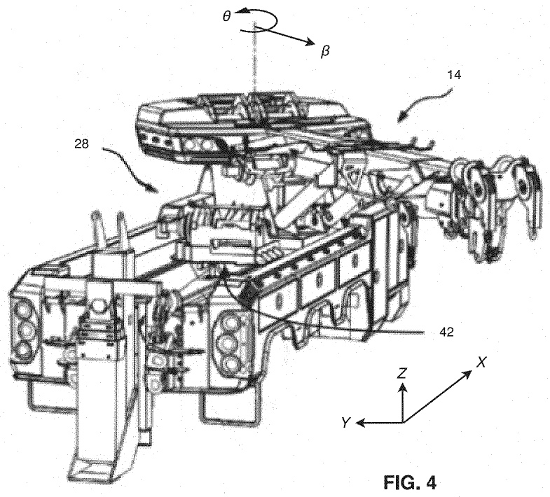

In a preferred embodiment, the data collected by the sensors 60 are transformed into dynamic load chart data in accordance with coordinates to be displayed on the operations center 122, including at least one but preferably both of chassis-based coordinates (coordinates X, Y and Z, depicted on FIGS. 2 to 8) and boom-based coordinates (coordinates θ and β, depicted on FIGS. 4 and 6), wherein some of the data in one coordinate (e.g., data relative to X and Y coordinates identifying the position of the object) are undergoing transformation along with changes occurring in the other set of the other coordinates (e.g., orientation 8 of the boom 14 to which is hooked the object). It is of course to be understood that some sensor data may be changed from one nature into another (for example from cable tension into object weight).

Referring now particularly to FIG. 6, the graphical representation, aka operations center 122 based on the dynamic load chart data is preferably divided in at least two zones 142, 144. The operations center 122 depicts in each of the zones 142, 144 at least part of the wrecker 10, e.g., a bird's eye view of the wrecker 10 and an elevation view of the telescopic boom 14, to provide context to the depiction of the dynamic load chart data.

According to a preferred realization, illustration of the first zone 142 comprises a wrecker representation 124 surrounded with at least one sector 132, and preferably a plurality of sectors 132, being delimited with a peripheral line 126 depicting limits of relative sectors based on operation characteristics of the wrecker 10 (e.g., maximum weight of the object to be lifted, limit angle/extension of operation of the telescopic boom 14). The first zone 122 further comprises a number of scale bars 128, preferably two scale bars 128A, 128B dedicated to the horizontal position of the head of the telescopic boom 14 relative to a reference position (e.g., the center of mass of the wrecker 10, the central support position based on the positions of the ground-contacting components, or the position of the base of the telescopic boom 14) helping the operator to understand the characteristics of the displayed sectors 132. Indicators 156A, 156B further depict current values on the bar scale 128A, 128B based on the position, orientation, and elevation of the telescopic boom 14. A legend 158 is further depicted providing the operation parameters associated with the sectors 132.

According to a realization, the number of sectors 132 is at least two, with a different color used to fill each of the sectors 132.

According to another realization, there is depicted a single sector 132, with a transparency level or other gradual depiction tool such as a color gradation, allowing to visually approximately the operation characteristics at any location within the sector 132.

According to a realization, characteristic(s) used to define a limit between two sectors 132 (depicted through e.g., line 126B) comprises the weight of the object to be lifted or percentage of the maximum weight operable in the operating conditions.

According to a realization, characteristic(s) used to define a limit between two sectors 132 (depicted through e.g., line 126B) comprises one or a combination of a proportion of the maximum lifting weight, the elevation angle, of the telescopic boom 14 and the extent of the telescopic boom 14.

According to a realization, characteristic(s) used to define a limit between two sectors 132 (depicted through e.g., line 126B) comprises the pressure undergone by the outriggers 24.

According to a preferred realization, illustration of the first zone 142 comprises a bird's eye view of the wrecker representation 124.

It is to be noted that the lines 126 limiting two sectors 132 (depicted through e.g., line 126B) are typically function of the morphology of the wrecker 10, or in other words the dimensions of the wrecker 10 and of its components, e.g., outriggers 24, extending outwardly from the chassis 16 of the wrecker 10. Typically, the sectors 132 dynamically change with e.g., the longitudinal displacement of the telescopic boom 14, the extension of the telescopic boom 14, the orientation of the telescopic boom 14, and the elevation angle of the telescopic boom 14.

According to a realization, the operations center 122 comprises a second zone 144 shows an elevation view of at least part of the telescopic boom 14, with two scale bars 129A, 129B showing the extension and elevation of the telescopic boom 14. An indicator 159 depicts the elevation angle of the telescopic boom 14.

According to a preferred realization, the angle of the elevation view of the telescopic boom 14 follows the orientation of the telescopic boom 14 and is thus independent from the longitudinal direction of the wrecker 10. Thereby, the elevation view of the second zone 144 remains constant regardless of the orientation of the telescopic boom 14.

The second zone 144 further comprises indicators 157A, 157B that depict the current value on the bar scale 128A, 128B based on the extension of the telescopic boom 14 and of the elevation of the head of the telescopic boom 14.

It is worth noting that depictions of the sector(s) 132 in the first zone 142 and the second zone 144 are coherent. As a result, the legend 158 may be shared by the first zone 142 and the second zone 144.

It is worth noting that the two zones 142, 144 are adapted to be displayed and updated at the same time, Thus, for instance a change in the elevation of the telescopic boom 14 would result in a modification of the indicator 156A in the first zone 142, of the indicators 157A and 157B in the second zone 144, and of the sectors 132 in both the first zone 142 and the second zone 144.

According to a realization, a third zone, partially depicted through third zone 145, is dedicated to provides additional more general information. Such additional information may comprise outrigger-related measurements 162A-162D, oil flow measurement 164, lift pressure 166, oil temperature 168, working pressure 170, and cable/drum-related measurements 172A-172E. Additional information may further comprise a weight evaluation of the object provided by the operator or weight measurement value(s) 174 and a stability notification 176 generated based on the processing of the prior-mentioned values. It is worth mentioning that measurements displayed on the operations center 122 may be values in units (e.g., in psi) or rating compared to a reference value (e.g., 80%).

According to a realization, the graphical representation depicts evolution of the lifting operation by depicting e.g., displacement, extension and/or rotation of the telescopic boom 14 during the operation and/or modification of the lifting limits 126 on the operations center 122. In other words, the processing unit 110 is modifying the graphic representation as the recovery operation evolves based on new readings of the sensors 60, aka providing an animation.

According to a preferred realization, the aid system 100 can be operated in two modes: a simulation mode, and an operating mode.

In the simulation mode, the operator provides or confirm initial information such as the weight of the object to be lifted, the initial extension of the outriggers 24, the initial forces exerted on the outriggers 24, etc. Following the entry of the initial data, the aid system 100 in the simulation mode may register simulation commands from the operator and provide a visual aid on the operations center 122 on the outcome of these commands according to operations limits of the wrecker 10. According to an embodiment, one or more simulations may be stored in memory 112 to be uses as a reference when performing a lifting operation.

In an embodiment, the aid system 100 is adapted to provide a proposed operating solution for lifting the object within the operation limits of the different components of the wrecker 10, or to minimize wear of the components of the wrecker 10.

It is thus to be understood that the aid system 100 comprises input means 140 allowing the operator to provide information on the lifting operation to be performed (e.g., work order number) and/or information not collected by the processing unit 110 otherwise (e.g., weight of the object to be lifted, distance of the object to be lifted, dimensions of the object to be lifted, etc.) in addition to means to initiation the simulation. Such information may for example be stored in association with a log of the lifting operation, or used by the processing unit 110 to generate dynamic load chart data.

According to a realization, the input means 140 comprises a touch screen and a (virtual or digital) keyboard.

In the operating mode, the aid system 100 provides a visual aid in the object lifting operation itself. During the lifting operation, the aid system 100 is adapted to provide about or in real time the measurements and graphical information to help the operator.

According to an embodiment, the aid system 100 is adapted, based on a selected simulation, to provide an operating sequence comprising a sequence of operations according to parameters, hereinafter called an operating route, to follow for the object lifting operation, with monitoring of changes in the operating conditions or the operator not following the operating route, aka having a too large gap between a current operating state and the operating route.

According to a realization, Indicator for the operating route (not depicted) may comprise arrows associated with indicators 156A, 156B, 157A, 157B and 159. The darkness and/or length of the arrows provides information on the “level” of operations necessary to remain following the operation route.

According to an embodiment, the aid system 100 comprises memory 112 adapted to keep a log of the simulation(s) and the lifting operation(s) for maintenance, and formation purposes.

According to an embodiment, a portion of the log may be transmitted live to a central whenever a condition is met, e.g., monitoring of the operating limits of the wrecker 10 being not respected.

According to a realization, the processing unit 110 is adapted to generate alert signals (e.g., sound or light) on the component used to operate the aid system 100 when the operation of the wrecker 10 gets close to an operating limit or reaches an operating limit.

According to a realization (not depicted), the processing unit 110 is connected to devices, controls and/or slave controllers, wherein the processing unit 110, upon detecting the reach of an operation limit, is adapted to transmit signals resulting in stopping the operation and/or requiring a confirmation command before the processing unit 110 allowing the operation to resume and to go beyond the operation limit. In one embodiment, the signal may consist in a hoovering notification displayed over the operations center 122, with the confirmation requiring the operator to enter a code.

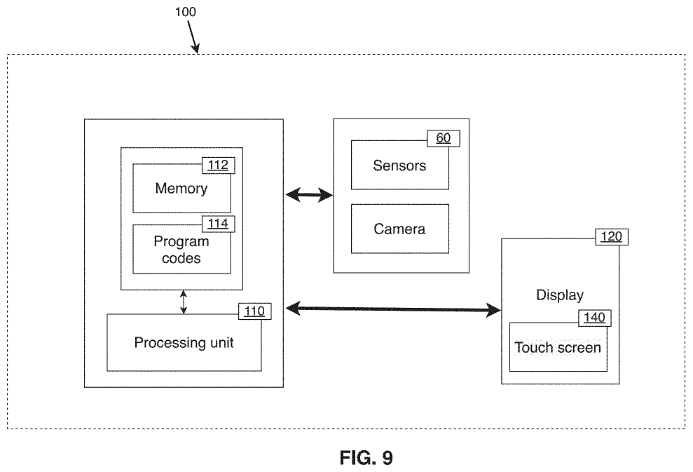

According to a realization depicted on FIG. 9, the wrecker 10 comprises one or more camera(s), radar(s), etc. connected to the processing unit 110 that is adapted to process the images and/or detection data, and to generate a graphical representation that depicts structures identified in the vicinity of the wrecker 10. The processing unit 110 is adapted to include in at least one zone 142, 144 a depiction of at least one of the object to be lifted and the structures present in the vicinity of the wrecker 10.

According to a realization, the processing unit 110 is adapted to merge the dynamic load chart data and the image/detection data into the two graphical interfaces of the first zone 142 and the second zone 144. Accordingly, the interface and the representation of the obstacles will change based on the elevation of the object, on the direction of the telescopic boom, etc. to provide a most accurate comprehension of what is an obstacle in relation with the lifting operation to the operator.

According to an optional realization, a projector (e.g., a laser projector) is mounted to the wrecker, e.g., at the apex of the telescopic boom 14. The projector is connected to the processing unit 110. The projector is adapted to project on the ground sector limits (e.g., sectors 132) for the operator to get a good understanding of the operation limits in the operating environment.

According to an optional realization, the dynamic load chart may be selectively or complementarily displayed in an augmented reality format in which is displayed an image of the vicinity of the wrecker 10 as captured by a camera or alternatively a construct of the vicinity based on images captured by one or more cameras, and an overlay depicting operating limit(s) of the wrecker 10 in its environment.

According, the present document contemplates variation in communication of the operating route to the operator, comprising depiction on a display, indications associated with controls, visual information provided through virtual reality devices, information projection in the vicinity of the wrecker, and machine-generated directions.

In it therefore contemplated therethrough that the present document contemplates variations in means of acquiring data intrinsic to the wrecker 10, data extrinsic to the wrecker 10, thus based on the environment or the interaction of the wrecker with the environment. The aid system 100 is adapted to process the intrinsic data and the extrinsic data to perform at least one of simulation of a lifting operation featuring an interface; a propose operating route for the lifting operation, and/or a guiding aid, visual or not, for the lifting operation to respect the operating route. According to configuration, the operating route may be limited to the operating condition without the operating limits of the wrecker, or limited to a narrower route close to e.g., a selected simulation operating route or a computer-generated optimized operating route.

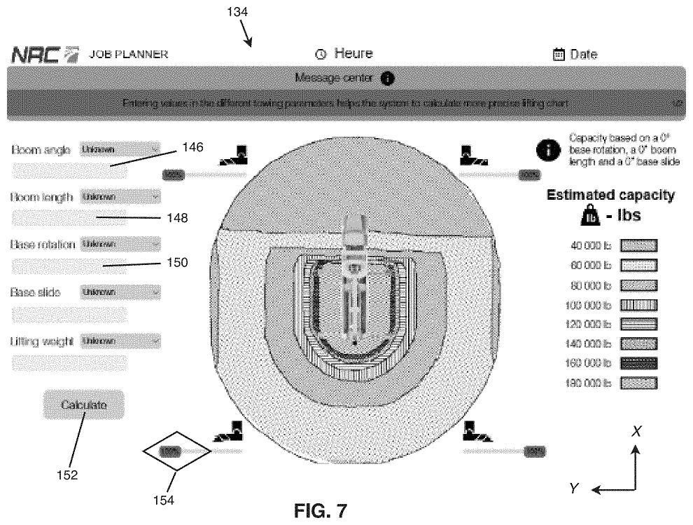

According to an embodiment, the simulation mode and the operating mode uses different interfaces. An exemplary interface for the simulation mode is depicted on FIG. 7. In this example, the aid system 100 requires the operator using input means to enter in the simulation mode and to provide environmental data based on which dynamic load chart data will be generated. In the exemplary simulation mode, the processing unit 110 uses data provided by the operator to generate the simulation graphical interface 134 without having to move the different components of the wrecker 10 to determine if the wrecker 10 in that “theorical” condition may perform the lifting operation.

The information the operator may provide comprises an estimated boom angle 146, an estimated boom length 148, an estimated base rotation 150. In a realization, these values are typically provided through the keyboard. The information the operator may provide also comprises an estimation of the maximum extent of the outriggers 24. These values are typically provided through the touch screen, by sliding a control or entering values 154 for each of the outriggers 24.

Accordingly, the aid system 100 herein described provides a solution for operators of wreckers 10 to prevent foreseeable sources of failures during lifting operations and to accelerate the speed in which the operator may determine the best set up for a lifting operation.

The interface of the simulation mode may comprise a calculation control 152 that, when used, triggers the processing unit 110 to update dynamic load chart data based on the information provided by the operator.

Accordingly, the aid system 100 presents the advantage of being available to an operator to at least avoid foreseeable sources of failure, and potentially to gain time by evaluating the condition beforehand, before the lifting operation through the simulation mode. Therethrough, the operator does not have to perform physical operations such as extend the outriggers 24 to identify problems that may lead to source of failure. The Prior Art, without the aid system 100, would require the operator to physically place the wrecker 10 in the evaluated setup, to begin the lifting operation, to experience that such setup is not acceptable to perform the lifting operation, something through failure of components and other times through avoidable operation of components, e.g., moving the telescopic boom 14 back to a stable position and retract the outriggers 24 to their collapsed position, and move the wrecker 10 to a new position, and so on until finding an appropriate setup.

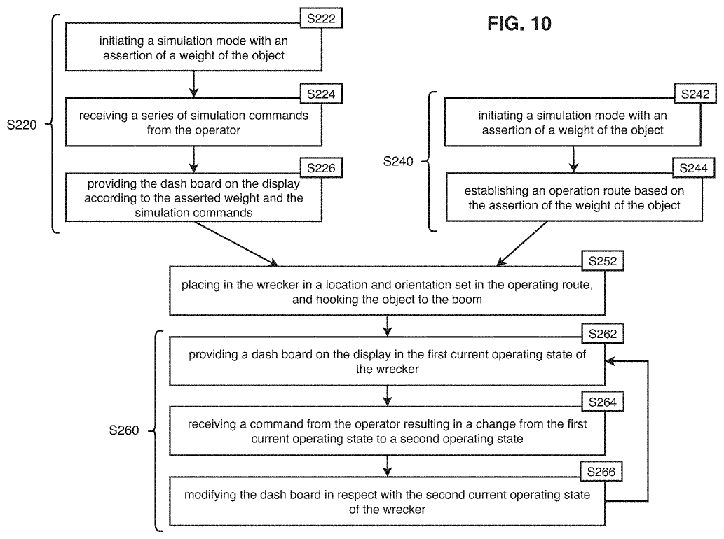

Referring to FIG. 10, exemplary possible uses of the aid system 100 in a recovery operation are illustrated through the following steps:

Step group S220 consists in performing a simulation with operators commands in preparation of the lifting operation.

Step S222 comprises initiating a simulation mode with an assertion of a weight of the object.

Step S224 comprises receiving a series of simulation commands from the operator.

Step S226 comprises providing the operations center 122 on the display 120, the operations center 122 depicting a dynamic load chart based on dynamic load chart data generated by the processing unit 110 based on the asserted weight and the simulation commands provided by the operator, the operations center 122 depicting concurrently a) an animation of at least part of a wrecker representation according to simulation commands, and a depiction of simulation operating conditions of the wrecker 10 according to the asserted weight and the simulation commands.

The operator may perform a simulation numerous times before initiating the recovery operation. As stated before, according to an embodiment, a simulation may be stored as an operating route for guidance in the relation of the recovery operation.

According to an embodiment, Step group S240 is available and consists in performing an automated simulation with operators commands in preparation of the lifting operation.

Step S242 comprises initiating an automated simulation mode with at least an assertion of a weight of the object;

Step S244 comprises establishing an operation route based on the assertion of the weight of the object.

At step S252, before entering the operating mode, the operator validates that the position and orientation of the wrecker 10 is compatible with the simulation (when one has been performed) and hooks the object to the hook extending from the telescopic boom 14.

Step group S260 consists in providing an operations center during a lifting operation.

According to embodiments, an operating route may or may not be associated with a recovery operation.

Step S262 comprises providing an operations center on the display, the operations center 122 depicting a dynamic load chart based on dynamic load chart data generated by the processing unit 110, the operations center 122 depicting a) at least part of a wrecker representation in a first current operating state of the wrecker 10, and a first limit depiction of an operating condition of the wrecker 10 in the first current operating state of the wrecker 10.

Step S264 comprises receiving a command from the operator resulting in a change from the first current operating state to a second operating state.

Step S266 comprises modifying the operations center for the operations center to depict a) at least part of a wrecker representation in the second current operating state, and a second limit depiction of an operating condition of the wrecker in the second current operating state of the wrecker.

Steps S264 and S266 are repeated until the end of the recovery operation, allowing the operator to follow the whole operation on the operations center 122.

As discussed before, the aid system 100 may comprise features not discussed in the exemplary use adding steps, such as storing a log of the simulation, storing a log of the lifting operation, generating alerts, detecting gap(s) between the assessment used for the simulation and the readings during the lifting operation, etc. with these features having an impact on the steps of the method. Regardless of these additional steps not being explained in relation with the method, they are intended to be contemplated as well through the description of these features in relation with the components of the aid system 100.

It is worth noting that an existing wrecker may be retrofitted with the aid system 100 by installing a series of sensors 60 adapted to collect intrinsic and extrinsic information. By updating the program codes 114 or register, the processing unit 110 may be adapted to any specific wrecker without requiring further physical adaptation that the installation of the sensors and the display 120 (when the processing unit 110, the memory 112 and the program codes 114 are housed in the display 120).

While preferred embodiments have been described above and illustrated in the accompanying drawings, it will be evident to those skilled in the art that modifications may be made without departing from this disclosure. Such modifications are considered as possible variants comprised in the scope of the disclosure.

1. An aid system for a wrecker adapted to perform a recovery operation of an object having a weight in an environment, the wrecker comprising a boom adapted to perform the recovery operation through which the wrecker either hauls or lifts the object, wherein the wrecker has operating limits, the aid system comprising:
sensors mounted to the wrecker adapted to collect:
intrinsic information associated with the wrecker, including detection of a first current operation state of the wrecker among a plurality of available operation states; and
extrinsic information on interaction of the wrecker with the environment or on the object;
a processing unit adapted:
to collect intrinsic data and extrinsic data from the sensors;
to process the intrinsic data, the extrinsic data, and the operation limits of the wrecker; and
to generate dynamic load chart data based on the processing of the data; and
a display adapted for displaying an operations center depicting a dynamic load chart based on the dynamic load chart data, the operations center depicting a) at least part of a wrecker representation in the first current operating state of the wrecker, and b) a limit depiction of an operating condition of the wrecker in the first current operating state of the wrecker.

2. The aid system of claim 1, wherein the intrinsic information comprises weight distribution of the wrecker.

3. The aid system of claim 1, wherein the intrinsic information comprises at least one of extension of the boom, orientation of the boom, and elevation angle of the boom.

4. The aid system of claim 1, wherein the extrinsic information comprises force exerted by the ground on outriggers laid over the ground.

5. The aid system of claim 1, wherein the sensors are adapted to detect a change from the first current operating state to a second current operating state, and for modifying at least one of a) the at least part of the wrecker representation and b) the limit of the operating condition in the operations center.

6. The aid system of claim 1, wherein the aid system is operable in a simulation mode through which an operating route is set, and an operating mode in which the wrecker operated in a series of current operation states, wherein in the operation mode the processing unit is adapted to detect gap between the current operating states of the series of current operating states and the operating route.

7. The aid system of claim 6, further comprising memory adapted to store at least one of the operating route, and the series of current operating states.

8. The aid system of claim 1, wherein the operations center comprises a first zone depicting a bird's eye view of the at least part of the wrecker and the limit depiction, and a second zone depicting an elevation view of at least part of the boom and the limit depiction.

9. The aid system of claim 1, wherein the operations center further comprises a representation of at least one of:
a force or a force rating exerted on an outrigger;
weight of the object;
elevation angle of the boom;
a force or a force rating exerted on a cable or on a drum;
oil flow;
oil pressure;
oil temperature; and
working pressure.

10. The aid system of claim 1, wherein the operations center comprises at least two scale bars, and at least two indicators each located on one of the scale bars based on the first current operating state.

11. The aid system of claim 1, wherein the operations center further comprises a stability notification processed by the processing unit based on the intrinsic data, the extrinsic data, the operating limits and the first current operating state.

12. A wrecker adapted to perform a recovery operation of an object having a weight in an environment, the wrecker comprising:
a boom adapted to perform the recovery operation through which the wrecker either hauls or lifts the object;
operating limits associated with components of the wrecker;
sensors mounted to the wrecker adapted to collect:
intrinsic information associated with the wrecker, including detection of a first current operation state of the wrecker among a plurality of available operation states; and
extrinsic information on interaction of the wrecker with the environment or on the object;
and
an aid system comprising:
a processing unit adapted:
to collect intrinsic data and extrinsic data from the sensors;
to process the intrinsic data, the extrinsic data, and the operation limits of the wrecker; and
to generate dynamic load chart data based on the processing of the data;
and
a display adapted for displaying an operations center depicting a dynamic load chart based on the dynamic load chart data, the operations center depicting a) at least part of a wrecker representation in the first current operating state of the wrecker, and b) a limit depiction of an operating condition of the wrecker in the first current operating state of the wrecker.

13. The wrecker of claim 12, wherein the intrinsic information comprises at least one of extension of the boom, orientation of the boom, and elevation angle of the boom.

14. The wrecker of claim 12, further comprising outriggers, wherein the extrinsic information comprises force exerted by the ground on the outriggers pressed against the ground.

15. The wrecker of claim 12, wherein the sensors are adapted to detect a change from the first current operating state to a second current operating state of the wrecker, and for modifying at least one of the representations of a) the at least part of the wrecker representation and b) the limit of the operating condition in the operations center.

16. The wrecker of claim 12, wherein the operations center comprises a first zone depicting a bird's eye view of the at least part of the wrecker and the limit depiction, and a second zone depicting an elevation view of at least part of the boom and the limit depiction.

17. The wrecker of claim 12, wherein the operations center comprises at least two scale bars, and at least two indicators each located on one of the scale bars based on the first current operating state.

18. A method of operating a wrecker equipped with a boom, sensors, and an aid system comprising a processing unit connected to the sensors and a display, the method comprising the steps of:
hooking an object having a weight to the boom;
providing an operations center on the display, the operations center depicting a dynamic load chart based on dynamic load chart data generated by the processing unit, the operations center depicting a) at least part of a wrecker representation in a first current operating state of the wrecker, and b) a first limit depiction of an operating condition of the wrecker in the first current operating state of the wrecker,
receiving a command from the operator resulting in a change from the first current operating state to a second operating state, and
modifying the operations center for the operations center to depict a) at least part of a wrecker representation in the second current operating state, and b) a second limit depiction of an operating condition of the wrecker in the second current operating state of the wrecker.

19. The method of claim 18, comprising, prior to the step of receiving a command, the steps of:
initiating a simulation mode with an assertion of a weight of the object;
receiving a series of simulation commands from the operator;
providing the operations center on the display, the operations center depicting a dynamic load chart based on dynamic load chart data generated by the processing unit based on the asserted weight and the simulation commands, the operations center depicting concurrently a) an animation of at least part of a wrecker representation according to simulation commands, and b) a depiction of simulation operating conditions of the wrecker according to the asserted weight and the simulation commands.

20. The method of claim 18, comprising, prior to the step of receiving a command, the steps of:
initiating a simulation mode with at least an assertion of a weight of the object;
establishing an operation route based on the assertion of the weight of the object; and
placing in the wrecker in a location and orientation set in the operating route.
